(19) United States
(12) Patent Application Publication
(10) Pub. No.: US 2008/0120390 A1
(43) Pub. Date: May 22, 2008

(54) DATE MANAGEMENT WITHIN A SOCIAL INTERACTION NETWORK

(75) Inventors: Merle Michael Robinson, Redmond, WA (US); Eric James Hennings, Seattle, WA (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: ICEBREAKER, INC., (US)

(21) Appl. No.: 11/855,929

(22) Filed: Sep. 14, 2007

Related U.S. Application Data
(60) Provisional application No. 60/825,851, filed on Sep. 15, 2006.

(51) Int. Cl. G06F 15/16

(52) U.S. Cl. 709/207; 709/204

(57) ABSTRACT

Systems (and corresponding methods) that enable users to transition virtual social networking encounters into the real world are provided. The innovation discloses mobile technologies that enable users to advertise a date to others, and for helping pairs of users to create a date on their mobile phone or online. Additionally, the innovation discloses systems that facilitate generation of ‘reverse’ advertisements. Still further, the innovation discloses mechanism of scheduling a date by way of asynchronous planning, and real-time date planning, for example via a third party.

### CROSS-REFERENCE TO RELATED APPLICATIONS

This application claims the benefit of U.S. Provisional Patent application Ser. No. 60/825,851 entitled ‘MOBILE SOCIAL NETWORK’, filed on Sep. 15, 2006 and is related to Ser. No. entitled ‘SOCIAL INTERACTION SYSTEM’, filed on Jul. 10, 2006, and to U.S. patent application Ser. No. ______ entitled ‘SOCIAL INTERACTION MESSAGING AND NOTIFICATION’, filed on ______, and to U.S. patent application Ser. No. ______ entitled ‘SOCIAL INTERACTION GAMES AND ACTIVITIES’, filed on ______, and to U.S. patent application Ser. No. ______, entitled ‘SOCIAL INTERACTION TAGGING’, filed on ______, and to U.S. patent application Ser. No. ______ entitled ‘LOCATION-BASED SOCIAL INTERACTION NETWORK’, filed on ______. The entireties of the above-noted applications are incorporated by reference herein.

### BACKGROUND

The Internet continues to make available ever-increasing amounts of information which can be stored in databases and accessed therefrom. Additionally, with the proliferation of portable terminals (e.g., notebook computers, cellular telephones, personal data assistants (PDAs), smart-phones and other similar communication devices), users are becoming more mobile, and hence, more reliant upon information accessible via the Internet. Accordingly, the connectivity available via the Internet is frequently used to chat, socialize and communicate with friends and family.

One particular area in which the Internet is becoming popular is in the field of Internet dating and other social interaction services generally. An Internet dating service, or online dating, allows people to meet and get acquainted online thereafter potentially engaging in a romantic relationship. Conventional dating services are oftentimes moderated by a third party who matches candidates based upon criteria and/or preferences.

These online dating services enable a user to create a profile which can contain information relating to physical as well as personal characteristics. As well, these online dating services enable a user to search profiles of other candidates in order to locate a match based upon a predetermined set of criterion. For example, a user can search upon physical characteristics such as age, height, weight, hair color, etc. As well, personal characteristics such as income, interests, hobbies, religion, etc. can be used to search profiles.

Online dating or Internet dating continues to expand in popularity as more and more people become acquainted with the Internet and its vast communication resources. Effectively, the seemingly anonymity of the Internet alleviates much of the apprehension and pressures associated with face-to-face communication felt by many individuals.

Online dating or internet dating services enable people to meet online and possibly develop a friendship, a romantic or even sexual relationship. These online dating services enable individuals to provide personal information, for example, age, gender and location. Accordingly, the services promote others to search these individuals using the profile criteria. As well, many dating services allow members to include a photo in their profile which can be searched by others.

In general, online dating services operate by the same criteria as typical relationships. However, factors specific to the nature of online communications may affect the experience. There are many positive factors that can inherently enhance the online experience. For example, online dating sites facilitate individuals to meet more people than they would without such sites. As well, online matchmaking sites enable individuals to easily browse other members' profiles before deciding to initiate communication.

Essentially, these online dating services enable users to break down geographic barriers while enabling users or members to learn more about a prospect or candidate before actually expending the time and effort to pursue a meeting. In today's busy society, the value added by the ability to pre-screen candidates is very desirable.

Conventional dating services have begun to migrate into today's mobile society. More particularly, recent developments have been directed to employing matchmaking services via mobile devices such as cell phones, smart-phones, etc. However, because these conventional mobile systems are nothing more than a mobile version of the traditional Internet dating systems, they have been plagued with slow response time, widespread deception and lack of interactivity.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems (and corresponding methods) that enable users to transition virtual social networking encounters into the real world. Aspects of the innovation disclose mobile technologies that enable users to advertise a date to others, and for helping pairs (or groups) of users to create a date on their mobile phone or online.

With regard to advertising a date, the innovation enables users to advertise a date for others to respond and potentially join. Yet other aspects disclose post of ‘reverse’ advertisements. In these ‘reverse’ advertisement scenarios, a user or users can advertise a date they would like to be taken on by somebody else. In either scenario, the innovation discloses mechanisms for creating an advertisement which can be posted for other users to act upon.

Still further, the innovation provides for users to search for, respond to and be notified with respect to date advertisements. These features can be performed via a mobile device (e.g., cell phone) as well as stationary computing devices (e.g., personal computer). Other aspects of the innovation are directed to scheduling a date which transitions participants from a virtual social networking environment into the real world. Aspects are directed to asynchronous planning by users that that have previously agreed to meet in the real world. Yet other embodiments are directed to real-time date planning, which can be more difficult than asynchronous planning because it requires that two or more parties communicate simultaneously. One real-time date scheduling aspect is directed to using a third party.

In yet another aspect thereof, contextual awareness and/or machine learning & reasoning (MLR) components are provided that employ a probabilistic and/or statistical-based analysis to infer an action that a user desires to be automatically performed. For example, MLR can be employed to automatically establish date parameters to advertise and/or schedule a date.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates date management in accordance with an aspect of the innovation.

FIG. 2 illustrates an example flow chart of procedures that facilitate establishing a date advertisement in accordance with an aspect of the innovation.

FIG. 3 illustrates an example flow chart of procedures that facilitate scheduling a date in accordance with an aspect of the innovation.

FIG. 4 illustrates an example block diagram of a communication system that enables date management in accordance with an aspect of the innovation.

FIG. 5 illustrates an example block diagram of an alternative communication system that facilitates advertising and scheduling a date in accordance with aspects of the innovation.

FIG. 6 illustrates an example block diagram of an advertising component the enables users to create, search, respond to and be notified of dates in accordance with aspects of the innovation.

FIG. 7 illustrates an example block diagram of a schedule component that enables users to schedule dates from the virtual to real world environment in accordance with an aspect of the innovation.

FIG. 8 illustrates an example communication system diagram that employs contextual awareness and/or machine learning & reasoning logic to automate one or more features of the innovation.

FIG. 9 is a schematic block diagram of an example portable handheld device according to one aspect of the subject innovation.

FIG. 10 illustrates a block diagram of a computer operable to execute the disclosed location-based architecture.

FIG. 11 illustrates a schematic block diagram of an example computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms ‘component’ and ‘system’ are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to ‘infer’ or ‘inference’ refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Mobile social networking services, such as mobile dating applications, assist users form virtual relationships that can, in accordance with the innovation, lead into the physical world. In Internet dating and mobile dating services, one goal is to meet in the real world for a date. Conventionally, in the virtual dating world, it is not easy to progress from searching profiles or flirting to actually making a date. The subject innovation discloses technology that assists users to 1) advertise a date to others, and 2) to create a date via a mobile device (e.g., cell phone) or online.

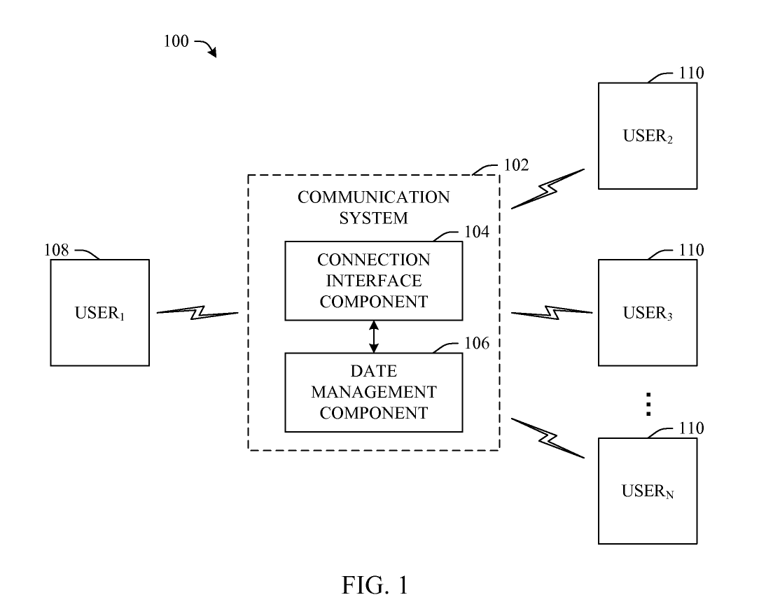

Referring initially to FIG. 1, the subject innovation is directed to a system 100 (and associated methods) that facilitates managing advertisement and scheduling of dates a social interaction system. It is to be understood that ‘date’ as used herein, is intended to refer to most any physical encounter or meeting whether romantic, friend-based, ‘plutonic,’ business, or the like.

As illustrated, the system 100 can include a communication system 102 having a connection interface 104 and a date management component 106. Together, these components manage and enable planning, scheduling and committing to a date between two or more individuals within a social networking environment. It will be understood that a date can be between two individuals, four individuals (e.g., double-date) as well as any other number as desired. In other words, although a traditional meaning of the word ‘date’ refers to a romantic or sexual encounter, as used herein, a ‘date’ can refer to most any meeting between two or more individuals. By way of specific example, business users or friends can be said to get a ‘date’ on the calendar—these types of ‘dates’ are to included within the scope of the innovation as described and claimed herein.

In one aspect, a first user 108 can advertise a date or schedule a date with any subset of users 110 within the network via the communication system 102. The date management component 106 can be used to manage dates from the planning stage, to a real world meeting, to feedback (if desired). As will be described infra, with regard to advertising a date, the innovation contemplates active advertisements as an offer to entice or interest a candidate. Additionally, a user can advertise a ‘reverse date,’ or in other words, a date that they would like to be taken on rather than taking someone else. These and other aspects will be described in greater detail with reference to the figures that follow.

The connection interface 104 enables many of the core functionalities of a social interaction service. For instance, the connection interface 104 can maintain user/member profiles, contact information, preferences, policies, etc. In other words, the connection interface 104 can provide mechanisms and means for users to locate each other by browsing personal characteristics, interests, locations, preferences, etc. of other users, members or subscribers.

In addition to providing the core social networking functionality, the connection interface 104 can also provide query, search and filter capabilities. These capabilities enable members to be logically matched based upon similarities, preferences, policies or the like—thereafter prompting a date, e.g., by way of the date management component 106. As will be described below, most any functionality of the system 100 (including the connection interface component 104), can be enhanced by the use of sophisticated logic mechanisms such as machine learning & reasoning (MLR) logic mechanisms. In these examples, the system 100 can learn, e.g., based upon statistics, history, feedback, etc., and can automatically act on behalf of a user.

The date management component 106 enables users to advertise dates as well as to schedule dates, once commitment (e.g., mutual-crush) is effected. It will be understood upon a review of the figures that follow, a user can act as a suitor and accordingly advertise a date in an attempt to capture interest in a candidate. In other aspects, a user can advertise a ‘reverse’ date which effectively identifies a date which they desire to be taken on by a potential host. In either example, it is to be understood that most any subset of users can be considered potential candidates for a date (whether ‘reverse’ or not). As well, it will be understood that a logical set can be selected, for example by considering profile information such as preferences, tags, locations or the like.

While many examples are described herein, it is to be understood and appreciated that other examples of date management social networking scenarios exist—which are to be considered within the scope of this innovation. By way of specific example, while a user can employ a cellular telephone to effect the advertising and/or scheduling of a date as described herein, it is to be understood that most any device can be employed in alternative aspects. For instance, examples that employ smart-phones, personal digital assistants (PDAs), laptops, personal computers (PCs), or the like are to be included within the innovation described herein.

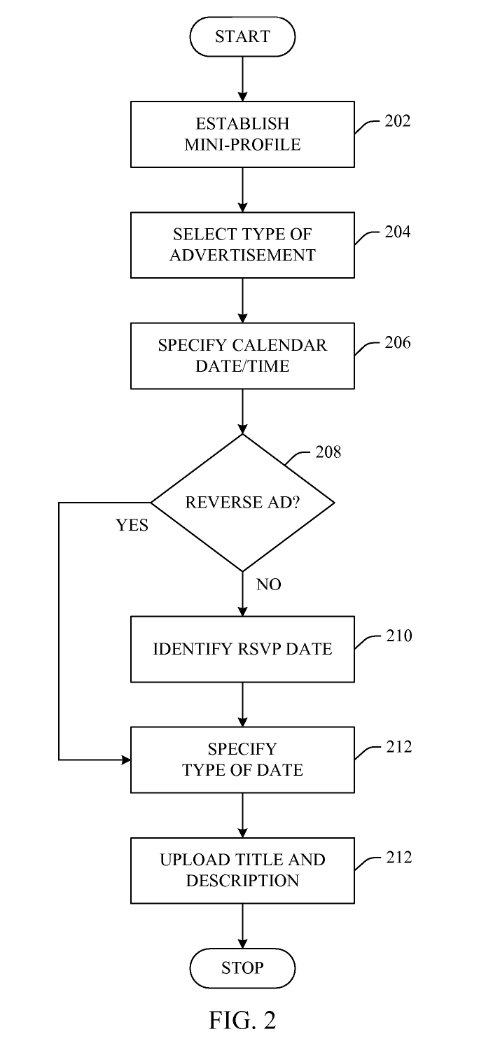

FIG. 2 illustrates a methodology of advertising and more particularly to creating a date within a social interaction environment in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, a mini-profile can be established which incorporates profile criteria such as age, username, city/state as well as a photo. Additional information can be included within the mini-profile, including, but not limited to, ‘community’ or ‘certified’ tags, income, profession, height, etc. It will be understood that most any criteria can be included within the mini-profile as preferred or desired.

At 204, the type of advertisement can be selected. Here, in one aspect, a user can select whether the advertisement is a ‘reverse’ advertisement or not. As used herein, a ‘reverse’ advertisement can refer to a date that a user would like to be taken on by someone else. By way of example, a user can advertise a ‘reverse’ date in an effort to be taken to a particular concert, restaurant, opera, or the like.

The day and/or time of the advertised date can be specified at 206. In this act, a specific date and/or time can be defined. Alternatively, a calendar range and/or time span can be defined—for example, ‘I would like to go to the ABC restaurant any Friday in September between 7:00 pm and 9:00 pm.’ While specific examples are set forth herein, it is to be understood that most any criteria and date parameters can be employed without departing from the spirit and/or scope of the innovation herein.

At 208, a determination is made to resolve whether the advertised date is a ‘reverse’ date. If not, an RSVP date can be identified at 210. It will be understood that, RSVP is an abbreviation for the French phrase “Respondez S'il Vous Plait”—translated in English, to “Reply Please.”

Once an RSVP date is set, or if the advertisement is determined to be a ‘reverse’ advertisement at 208, the type of date can be specified at 212. Examples of types of dates can include, but are not limited to, dinner, movie, concert, sporting event, bike ride, etc. Once the type is specified, a title and description of the date can be uploaded (or otherwise injected) at 212.

At 212, the title and description can be uploaded in most any format. For example, text can be used to name and describe the date. In other aspects, video, pictures and/or audio can be used to provide a title and/or description of the created date. In aspects, audio and/or video clips can be recorded using audio and video capture components of a device, for example, microphone and optics of a cell phone. Additionally, if desired, clips can be prerecorded and uploaded or imported as desired.

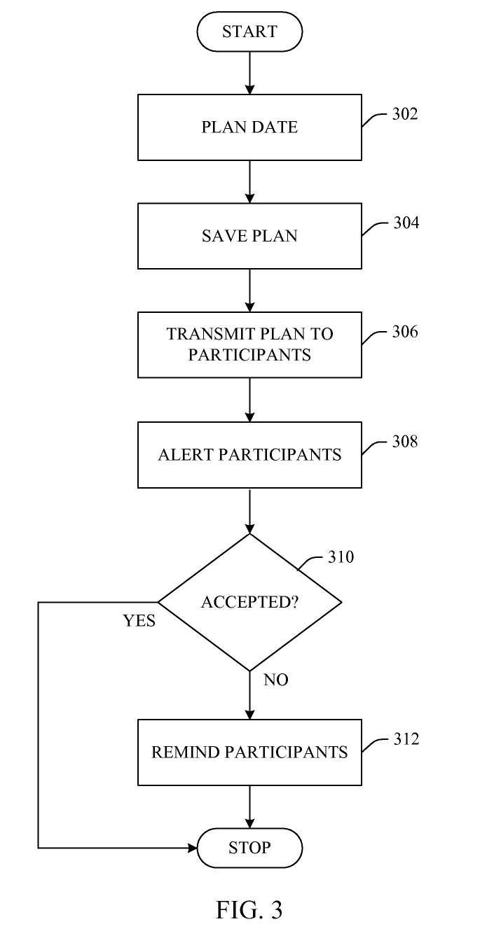

FIG. 3 illustrates a methodology of making a date in accordance with an aspect of the innovation. At 302 the date can be planned as illustrated in FIG. 2. It will be understood that dates can be planned asynchronously or in real-time as desired. In other words, input from either or all participants of a potential date can be considered within the planning phase.

The plan can be saved at 304. More particularly, the details of a planned date can be saved in a local store, remote store, cloud or the like. It is to be understood that, in other aspects, a user can unilaterally plan a ‘dream date’ without having any particular participants in mind. Rather, whether a ‘reverse’ date or not, a user can essentially post a date in order to entice or interest other candidates of the social network to participate.

As described above, a ‘date’ does not have to refer to a romantic encounter. Rather, although romantic encounters are included, a date can also be a mere meeting of friend or other acquaintances. By way of specific example, a user can post a ‘date’ in an effort to lure or interest other members to talk about a topic, for example sports, eating disorders, marital problems, childcare, among others. Most any reason or topic of a ‘date’ is to be included within the scope of this innovation.

At 306, the plan can be transmitted to potential participants of the date. In a one-to-one scenario, the date will be transmitted to the other party. In a one-to-many scenario, the plan will be sent to all of the potential recipients. Still further, in the scenario where the recipients are unknown, the date can be transmitted to any defined group or subset of available members of the social network.

In the third example above, it will be understood that potential participants can opt-in or opt-out of receiving unsolicited date offers. Still further, sophisticated logic can be built in to better define a group of potential participants to the date. Here, profile criteria can be used to effectively filter potential dates from persons of interest or persons where interests match, tags match, etc. While a mini-profile can be employed with respect to some criteria, here, more deep-rooted knowledge of a user, their interests, their affiliations (e.g., ‘certified’ tags, contact list), etc. can be used to determine or infer when a plan should be sent or received by a user.

At 308, the participants can be alerted. The alerts and notifications can be communicated in the same or similar manners as described with reference to the Related Applications set forth above. For instance, alerts can be transmitted in text, video, audio, or picture formats as desired. In examples, SMS (short messaging service) or MMS (multi-media messaging service) can be employed to communicate the plan to eligible participants.

Participant replies can be monitored and a determination made at 310 to identify if the date is accepted. If the date is accepted, a stop block is reached and the parties continue in the physical world to meet. On the other hand, if the date is not accepted, a reminder can be sent at 312 to prompt participants to reply. As above, the reminder(s) can be sent in most any manner desired. These reminders can be sent consistent with the notifications, alert and messages described in detail with reference to the Related Applications set forth above.

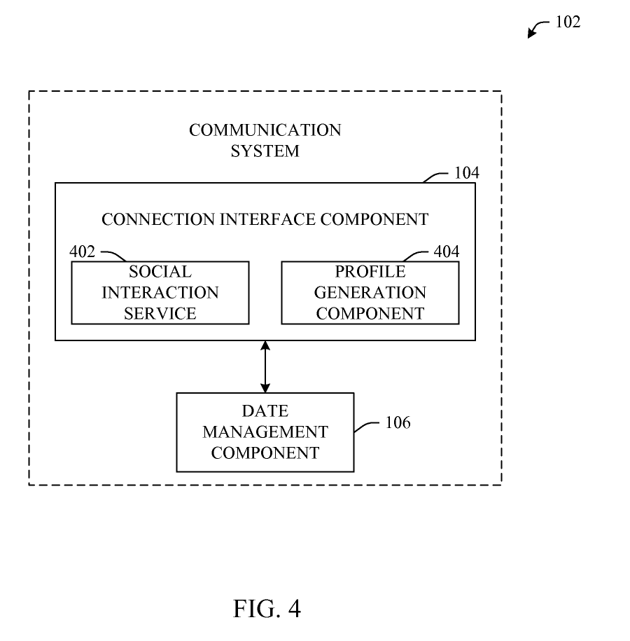

Turning now to FIG. 4, an alternative block diagram of communication system 102 is shown. As described with reference to FIG. 1, the communication system 102 can include a connection interface component 104 and date management component 106. As illustrated in FIG. 4, the connection interface component 104 can include a social interaction service 402 and a profile generation component 404. Each of these components will be described in greater detail infra.

Although the social interaction service component 402 and the profile generation component 404 are shown inclusive of the connection interface component 104, it is to be understood that these components 402, 404 can be located external and/or remote from the connection interface component 104 (and communication system 102) in alternative aspects.

In one particular aspect, the social interaction service component 402 can be representative of a social networking or mobile dating service where members/candidates can define a profile and/or browse profiles of other members/candidates. Although a mobile dating service is described herein, it is to be understood that the features, functions and benefits of the innovation (e.g., date management) can be employed in other scenarios where an application or service is used to schedule a date, meeting, encounter, rendezvous or other real world meeting of individuals.

The connection interface component 104 can also include a profile generation component 404 which enables a user to define preferences and/or policies associated with preferred candidates ultimately located by the social interaction service 402. For instance, a user can select parameters that define which candidates to search/query profiles based upon gender, marital status, age, geographic location, among others. Similarly, the profile generation component 404 enables a user to define other settings such as notification protocol preferences, messaging protocol preferences, acceptable time windows to receive notifications, acceptable devices, email addresses, phone numbers, etc. to receive notifications and/or messages. These examples are described in detail with reference to the Related Applications that are incorporated by reference above.

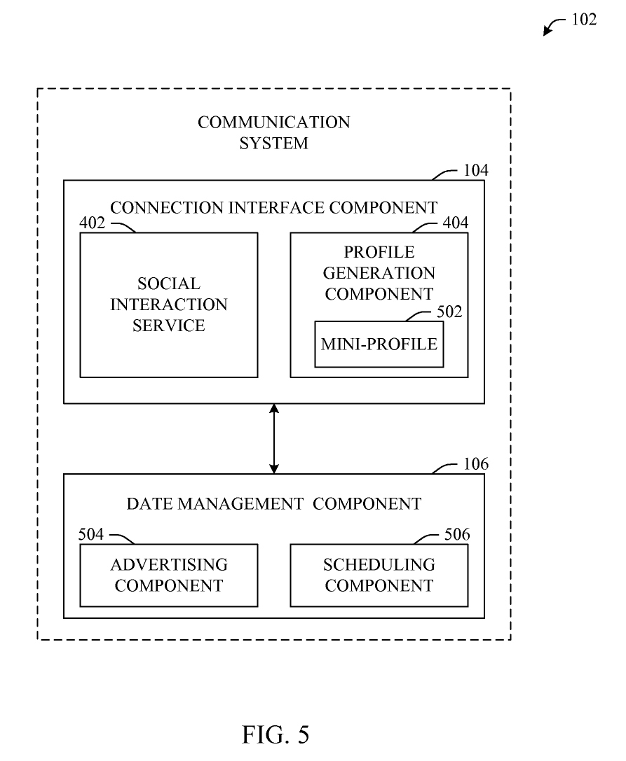

In addition to personal criteria of candidates, as shown in FIG. 5, the profile generation component 404 can maintain a mini-profile 502. A user(s) mini-profile can be used to effect much of the date management functionality described herein. For instance, in one embodiment, the mini-profile can include: user age, username, photo, city/state, zip code and a link to profile. As well, multiple users may be mentioned in case the scenario refers to a multiple person date such as a double-date. It is to be understood that most any criteria or parameters can be included within a mini-profile—which is to be included within the scope of the innovation and claims appended hereto. These and other examples will become more apparent upon a review of the figures that follow.

With continued reference to FIG. 5, there is illustrated yet another example block diagram of communication system 102. As shown, and as described above, the profile generation component 404 can include a mini-profile 502 which can be employed to manage dates (e.g., acceptances and offers) within a social networking experience. The mini-profile component 502, in addition to defining descriptive characteristics or parameters of a user, can include most any preferences, affiliations, etc. as desired. For example, the mini-profile component 502 can, in one embodiment, identify a cuisine preference or sports team interest. This information can be used by the date management in planning and setting up dates between users.

With continued reference to FIG. 5, the date management component 106 can include an advertising component 504 and a scheduling component 506. Essentially, the advertising component 504 enables a date advertisement to be posted whereas the scheduling component 506 enables a date actually to be planned and scheduled between users. Generally, aspects of each component (504, 506) can be associated to the methodologies described in reference to FIGS. 2 and 3 respectively above.

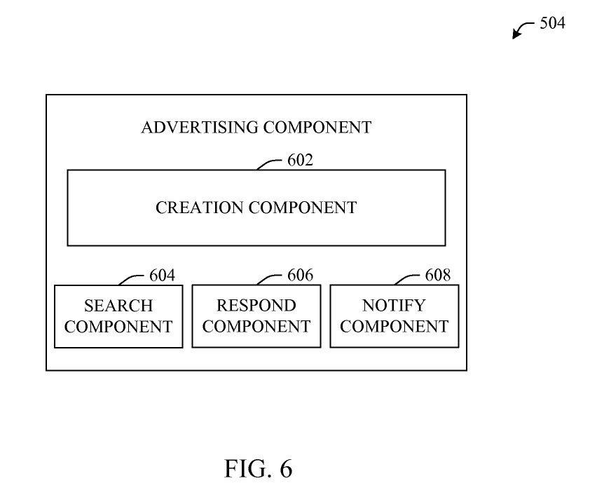

Turning now to FIG. 6, a block diagram of an example advertising component 504 is shown in accordance with an embodiment. Generally, the advertising component 504 can include a creation component 602 that facilitates planning of a date. Additionally, a search component 604, respond component 606 and notify component 608 can be employed to effect planning a date in accordance with aspects.

As described above, in Internet dating and mobile dating services, one goal is to meet in the real world for a date. Conventionally, in the mobile dating world, it is not easy to progress from searching profiles or flirting to making an actual real world date. The advertising component 504 (and corresponding subcomponents) facilitates advertising a date to others, and for helping users to create a date by way of their mobile phone or online.

It will be understood that how a potential mate plans a date is very important to his/her attractiveness. Thus, the innovation supplies the capability to create and/or advertise a date for others to respond and potentially join. Also, ‘reverse’ advertisements can be facilitated by way of the innovation. In accordance with a reverse date, a user or group of users can advertise a date they would like to be taken on by somebody else. As described above, it is to be understood that a date is not to be limited to a romantic encounter but rather is to include most any meeting of individuals for most any reason.

As shown in FIG. 6, the advertising component 504 can include a creation component 602 that assists users in posting a date advertisement to another user or group of users. Since users will be advertising this capability over the phone, the parameters of the date can be limited and easy to enter. As well, auto-fill and other time-saving technologies can be employed to assist a user in creating an advertisement.

Date advertisements could include many parameters which define or otherwise describe the date. Accordingly, the creation component 602 can facilitate defining and aggregating parameters that define a date. For example, as described above, a user(s) mini-profile will be generated automatically to include factors such as, but not limited to, age, username, photo, city/state and link to social network profile. Additionally, the mini-profile can include reference to multiple users in the event that the date describes a multiple person date such as a double-date.

The creation component 602 enables a user to determine a type of advertisement, for example whether the user(s) chooses between a reverse advertisement or not. Other parameters such as venue, timing, RSVP (reply please) date, type of date (e.g., movie, dinner), title, description, etc.

Venue refers to the date location or locations, depending on the number of elements in the date. For example, a park or specific restaurant can be a selected venue for a date. Entry of timing information can include a specific day and time, or alternatively can be open-ended. In accordance therewith, users can enter this information easily through a calendar, pull-down menu for the times or free format as desired.

Similarly, the RSVP date can be entered via a calendar, pull-down menu or free format as desired. Still further, the type of date can be entered by way of the creation component 602 (and corresponding user interfaces). For instance, a pull-down menu, auto-fill input, list selection or the like can be employed to present the user with options, including but not limited to, movie, dinner, concert, bike ride, etc. While the aforementioned pull-down or other lists can be pre-programmed or pre-populated, it will be understood that the list can also be dynamically generated by way of feedback together with machine learning & reasoning (MLR) logic. In other words, the creation component 602 can learn patterns and trends of users and thereafter automatically populate fields by which a date can be advertised.

The title and description can include a detailed description of the date. Since it is often difficult to type long descriptions on the phone, users could upload or create audio descriptions using their phone's microphone in accordance with aspects. Similarly, users could also capture photographs and/or video if the phone has a camera or, alternatively, upload pre-recorded media.

If there are two or more users planning a date (e.g., double date), one of the users could provide the username(s) of any other advertisers upon creation by way of the creation component 602. These other advertisers can be alerted to edit, append and/or approve the advertisement. After each edit or approval, all the advertisers will be alerted until all have approved. Once approved by all of the advertisers, the advertisement will be posted and made available to potential participants by way of the social network.

The search component 604 enables users to search advertised dates. For example, the component 604 enables users to search both advertised dates and ‘reverse’ advertised dates by any of the entered information including, but not limited to, user, location, time, age of advertiser, date, RSVP date, type of date, and/or word search. It will be understood that most any search algorithm, mechanism, engine as well as search criteria can be employed without departing from the spirit and/or scope of the innovation.

The respond component 606 enables a user to respond to (or accept) a date. Here, users can simply respond to an advertisement by clicking on a response link or otherwise accepting the terms of the date. If desired, the responder(s) can enter a personal message and username(s) (if not logged in already). If the user is logged into the social network environment, the username can be automatically populated.

Subsequently, the notify component 608 can be used to alert the advertiser of the acceptance. In aspects, it will be understood that the advertiser can be notified by way of an SMS or through GPRS (General Packet Radio Service) to an application. As described in the Related Applications set forth above, most any protocol, including but not limited to, text, voice, video, picture messaging can be employed to notify parties in connection with features, functions and/or benefits of the innovation.

The advertiser can be offered to accept the response(s) by way of the notify component 608. If the response(s) is accepted (e.g., via the respond component 606), and matches the number of openings (e.g., two acceptances for a double date), then the advertisement is immediately removed from the system. For example, if users search on an old date, the system can advise that the date is “no longer available” or “expired,” depending on whether the date passed the RSVP date without a response. It will be appreciated that the notify component 608 can be used to alert the participants of the date with reminders.

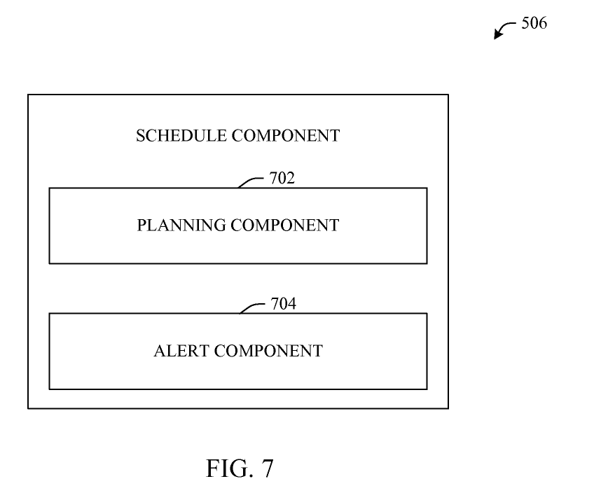

Turning now to FIG. 7, an example block diagram of a schedule component 506 is shown. As illustrated, the schedule component 506 can include a planning component 702 and an alert component 704. Where the advertising component 504 of FIGS. 5 and 6 illustrates components directed to pre-acceptance and acceptance of a date by way of advertisement, the schedule component 506 includes components that facilitate post-acceptance functionality. In other words, the schedule component 506 is directed to scenarios where users agree to go on a date and subsequently have to plan and consummate such a plan.

When users connect (e.g., romantically connect) through the Internet or other network (e.g., mobile dating), they often would like to take the interaction to the next level through a physical encounter. Here, the schedule component 506 assists users plan these real world dates. In aspects, the schedule component 506 assists single users as well as multiple users (e.g., a double date) plan a date.

A first scenario is directed to asynchronous planning of a date. Asynchronous planning is a simple way for users to plan a date once they have agreed to go on the date. Here one user from the set of participants plans the date as described above with reference to the advertising of a date scenarios set forth supra. Here, the planning component 702 can include similar functionality of the creation component 602 described above with reference to FIG. 6.

Since users will be creating the date over the phone, the planning component 702 can provide for the parameters of the date to be limited and easy to enter. Essentially, as described above, parameters of a date can include, but are not limited to include a venue, time/date, type of date, as well as a title and description.

Venue can refer to the date location or locations, depending on the number of elements in the date. Specific day and time (or open-ended) can also be included within the parameters by the planning component 702. In this regard, users will be able to enter this information easily through a calendar, pull-down menu or the like. The type of date can also be made easy to designate by way of a pull-down menu, auto-fill, pre-structured list or the like. For example, a type of date can include, movie, dinner, concert, opera, bike ride, etc.

Moreover, a title and description of a date can be defined via the planning component 702. Since it is often difficult to type long descriptions on the phone, users could create audio descriptions using their phone's microphone. As well, speech to text conversion can be employed to automatically convert a spoken description to text which can ultimately be sent to participants. In other aspects, users could also capture photographs and/or video if the phone has a camera. Still further, descriptions (e.g., text, audio, video, visual, etc.) can be pre-generated and uploaded as desired.

Once the planning is complete, the planning component 702 effects saving the parameters of the date. As well, the alert component 704 can facilitate transmission of the parameters to all the participants. If desired, the participants can be alerted to edit, append and/or approve the date. After each edit or approval, all the participants can be alerted (e.g., via alert component 704) until all have approved the parameters.

Thereafter, the participants can be alerted to the date with reminders until the date takes place. It will be understood and appreciated that the alert component 704 can employ most any protocol to notify and/or alert participants. For example, the alert component 704 can employ text, audio, video, picture messaging or the like to alert or notify a participant.

The planning component 702 can also facilitate real-time planning of a date or encounter. It will be understood that real-time date planning can be more difficult than asynchronous planning because it requires that two or more parties be on the phone simultaneously. For example, data speeds could cause lags in the process, thus, the subject innovation accounts for this lag.

There are at least a few ways to create a date in real time. In most all cases, users would access the make-a-date technology (e.g., planning component 702) directly from their chatting (or social networking) experience or while surfing through their ‘contact list.’ It will be understood that a contact list is a mutually approved list of people that can share presence and other personal (as well as descriptive) information. In specific aspects, it can be presumed that users often would want to create a date with members of their contact list.

A simple way to create a date in real-time is through a third party. This third party can be a general concierge service or can be run by a specific establishment (e.g., a restaurant) or set of establishments (e.g., chain of restaurants). In planning a date through a third party, the user can select from a menu of third party services. Once all users (a subset of users or a designated ‘planner’) agree upon a particular third party, a communication (e.g., call) can commence.

Here, users or participants can be contacted by the selected third party via a conference server (e.g., connection interface component 104 of FIG. 1). In one aspect, the users and the third party can discuss date options and parameters by voice. Other aspects include, but are not limited to, discussions by text, video picture messaging, or the like. These additional aspects are to be included within the scope of the specification and claims appended hereto. Once key details are determined, the communication ends. As well, it will be understood that the planning of parameters can take place within a series of communications as desired.

Thereafter, the users are alerted to confirm the details, either through an application, WAP (wireless access protocol), SMS or other desired protocol. Thus, users confirm the date parameters and the date is scheduled. In addition to prompting confirmation, the alert component 704 can also be employed to send reminders until the date actually takes place. It will be appreciated that, in aspects, users can opt-out of receiving reminders and other alerts. Accordingly, users are able to select protocol types for most any messaging and notifications.

In accordance with other aspects, voice and data services can occur simultaneously. In these scenarios, users could watch their screen as the third party makes choices based upon their verbal comments. Users would be able to provide feedback to the third party as they visually comprehend the arrangements that the third party is making on their behalf. Similarly, confirmation and reminders can occur in the phone call as the users might opt to confirm in the call because they would have visually seen the arrangements.

Turning now to a discussion of planning a date without a third party, or using only data services—here, users can use a mobile data application or Internet application to plan a date. The innovation enables simultaneous voice and data when planning a date.

In planning a date, the users agree on at least two main elements: when to do it and what to do. The potential voice and data process could take a number of steps. First, upon beginning the setup, users must both be logged into the social network service so that the service knows identity of the parties. For example, the service will know the identities in case service is interrupted and the remaining steps must be completed at a later time.

Turning to a discussion of planning the time, both users' screens can employ calendar graphics to help users suggest date ranges. The server can then determine the overlap and alerts users to specific days that are good for both. At this point, the users can select a specific date and time, and view the choice of the other user simultaneously. Accordingly, the users can adjust their choices until there is agreement and confirmation.

Thereafter, the users can plan the type of date. Here, users can be shown a number of icons that represent different types of dates (e.g., dinner, sports event, movie, etc.). In an embodiment, each user selects three to five potential date types, for example, in order of preference. These choices are marked on the user's screen with numerals next to the icons in a specific color to indicate that they are his/her own choices.

The other user can see those choices with colored numerals next to the icons in a different color to indicate that they are the choices of the other user. It will be understood that most any designations can be used without departing from the spirit/scope of the innovation.

Once users have completed their choice, the server then suggests one or two (or more) matches, depending on the overlap in preferences. Then, each of the users pick one (or more) of the options. As one user picks an option, it is highlighted on the other user's screen. Thus, the users can communicate their preferences until they both choose the same option and confirm.

Further details can be planned by the planning component 702. Once the users agree on a time and type of date, they can choose a venue (or combination of venues). This can be easily done by text (or other desired protocol) commentary between the users. One side of the screen can show the suggested venues from him/her and the other side will show the other user's suggestions until they land on a mutually agreed location.

In addition, on the initial screen there can be icons from vendor partners that correspond to the type of date. Users can easily click on those icons, and, if both agree, the date will automatically be set at the venue based on the preset times from the previous step. At any time in the process, users can go back and forth between steps in the planning. For example, users could be deciding on the type of date and decide instead to return to the previous step and change the date. In addition, the application can prod the users along if the process is moving slowly. The prodding can be in the form of witty text comments such as “be a man and make a decision” to the male participant.

Yet another example of the planning component 702 is directed to planning without a third party but rather using only data and voice services combined. In this case, it is to be understood that voice and data services can be combined by the mobile operator and or Internet provider using VoIP (Voice-over-Internet Protocol) or other suitable technology. This service can be very similar to the above service which only employs data services, except users can come to agreement quicker because they can speak to each other during the process.

In fact, the service could run in the same or substantially similar order except for planning the details. Here, one user could take the initiative and type in the details while talking to the other person. The second (or subsequent) user would see the information appear on their screen as the first user types and can confirm via verbal comments.

Regardless of how the date was planned, the innovation can provide users the ability to view reserved and confirmed dates for themselves. They can access these dates via a main menu within the mobile dating service (e.g., social interaction service 402). Once users are viewing their list of dates, they can opt to view the detail and even cancel the date. Canceling may involve a penalty if the third party so demands. As well, modifications and cancellations can be captured by way of feedback—which can be presented to other users or used to automatically make decisions on behalf of a user (e.g., MLR).

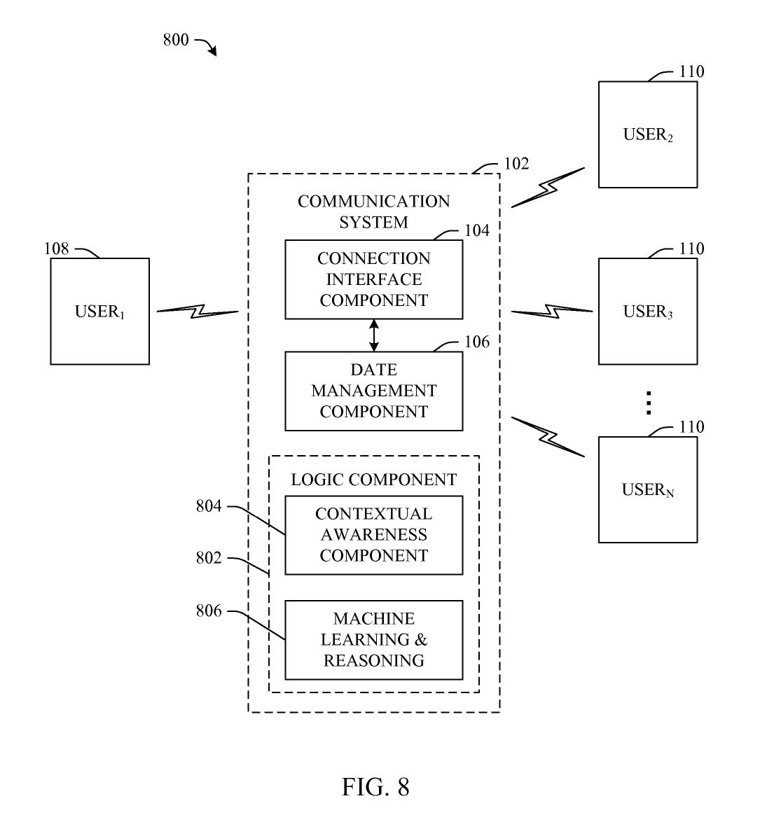

Referring now to FIG. 8, an alternative system 800 in accordance with an aspect of the innovation is shown. Generally, system 800 can include a communication system 102 that facilitates planning and scheduling dates between users (e.g., 108, 110) as described herein. More particularly, the communication system 102 can include a connection interface component 104 and a date management component 106 (together with subcomponents) as described above. Still further, a logic component 802 having a contextual awareness component 804 and/or a MLR component 806 is provided. This logic component 802 (and optional subcomponents 804, 806) can provide for sophisticated decision-making capabilities of the communication system 102 generally.

In particular, the contextual awareness component 804 can be employed to consider most any contextual factor when planning or scheduling a date as described herein. In examples, weather, mood, completed activities, etc. can be factored into decisions related to planning and scheduling a date. Still further, factors such as engaged activity, calendar appointments (schedule), tasks, individuals in proximity, upcoming activities, or the like can be factored into decision logic related to planning and scheduling dates.

By way of specific example, the logic component 802 can access a user's personal information manager (PIM) data in order to establish how busy their day has been. For instance, if the PIM data indicates that a user has been in high-level strategy meetings all day, the date management component 106 can suggest a movie or even to forgo a date until a later time. It will be understood that a movie can sometimes help a person unwind from a busy day where conversation over dinner may not be as conducive. While specific examples are given, it is to be understood most any contextual factor can be considered in the functionality of the communication system 102.

Still further, MLR logic 806 can be employed to automate one or more functions of the communication system 102. For instance, the innovation can employ MLR mechanisms which facilitate automating one or more features in accordance with the subject innovation. The subject innovation (e.g., in connection with selecting parameters of a date) can employ various MLR-based schemes for carrying out various aspects thereof. For example, a process for determining planning or scheduling parameters of a date can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module.

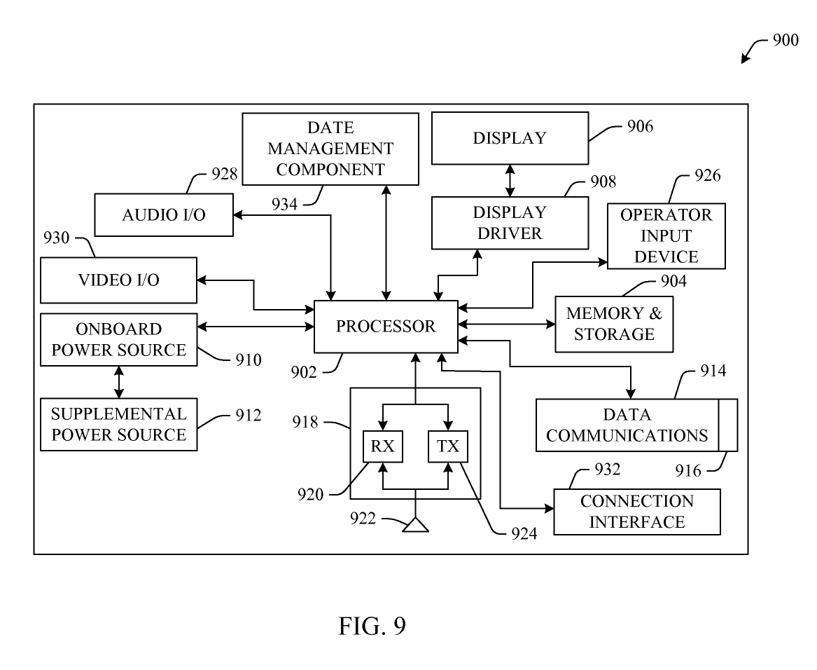

Referring now to FIG. 9, there is illustrated a schematic block diagram of a portable hand-held device 900 according to one aspect of the subject invention, in which a processor 902 is responsible for controlling the general operation of the device 900. The processor 902 can be programmed to control and operate the various components within the device 900 in order to carry out the various novel functions described herein. The processor 902 can be any of a plurality of suitable processors. The manner in which the processor 902 can be programmed to carry out the functions relating to the subject innovation will be readily apparent to those having ordinary skill in the art based on the description provided herein. As described in greater detail supra, contextual awareness and/or MLR components can be used to effect an automatic action (and sophisticated decision-making) of processor 902.

A memory and storage component 904 connected to the processor 902 serves to store program code executed by the processor 902, and also serves as a storage means for maintaining information such as data, services, metadata, device states, electronic mail messages, or the like. The memory 904 can be a non-volatile memory suitably adapted to store at least a complete set of the information that is acquired. Thus, the memory 904 can include a RAM or flash memory for high-speed access by the processor 902 and/or a mass storage memory, e.g., a micro drive capable of storing gigabytes of data that comprises text, images, audio, and video content. According to one aspect, the memory 904 has sufficient storage capacity to store multiple sets of information relating to disparate services, and the processor 902 could include a program for alternating or cycling between various sets of information corresponding to disparate services.

A display 906 can be coupled to the processor 902 via a display driver system 908. The display 906 can be a color liquid crystal display (LCD), plasma display, touch screen display or the like. In one example, the display 906 is a touch screen display. The display 906 functions to present data, graphics, or other information content via a UI. Additionally, the display 906 can display a variety of functions that control the execution of the device 900. For example, in a touch screen example, the display 906 can display touch selection buttons. In operation, when the notifications and/or messages are delivered, the UI, via display 906, can effectively convey the notifications and/or messages to a user. As described above, these notifications and/or messages can be text, visual, audio or combinations thereof.

Power can be provided to the processor 902 and other components forming the hand-held device 900 by an onboard power system 910 (e.g., a battery pack). In the event that the power system 910 fails or becomes disconnected from the device 900, a supplemental power source 912 can be employed to provide power to the processor 902 (and other components (e.g., image capture device)) and to charge the onboard power system 910. The processor 902 of the device 900 can induce a sleep mode to reduce the current draw upon detection of an anticipated power failure.

The device 900 includes a communication subsystem 914 having a data communication port 916, which is employed to interface the processor 902 with a remote computer, server, service, or the like. The port 916 can include at least one of Universal Serial Bus (USB) and IEEE 1394 serial communications capabilities. Other technologies can also be included, but are not limited to, for example, infrared communication utilizing an infrared data port, Bluetooth™, wireless protocols, etc.

The device 900 can also include a transceiver section 918 in operative communication with the processor 902. The transceiver section 918 includes a receiver 920, which receives signals from a remote device via an antenna 922 and can process the signal to obtain digital information therein. The transceiver section 918 also includes a transmitter 924 for transmitting information (e.g., data, service) to a remote device, for example, in response to manual user input via a operator input 926 (e.g., a keypad).

The transceiver section 918 facilitates communication with other portable devices and/or host computer systems. In furtherance thereof, an audio I/O section 928 is provided as controlled by the processor 902 to process voice input from a microphone (or similar audio input device) and can transmit audio output signals (from a speaker or similar audio output device).

In another implementation, the device 900 can provide speech recognition capabilities such that when the device 900 is used as a voice activated device, the processor 902 can facilitate high-speed conversion of the voice signals into text or operative commands. For example, the converted voice signals can be used to control the device 900 in lieu of using manual entry via the keypad 926. As well, in another aspect, voice commands can be employed to effect coupling and/or decoupling from a remote system. Still further, voice activated commands can be employed to ‘crush’ (select) or ‘flush’ (pass) with regard to presented candidates. Most any appropriate functionality of the innovation can be controlled via voice commands.

Similarly, video signals can be input and/or output via the video I/O component 930. The video I/O component 930 can include an image capture device capable of providing video communications via the mobile device 900.

Other components such as a connection interface 932 and date management component 934 can be provided within the housing of the device 900 to effectuate functionality described supra. For example, the connection interface 932 can be employed in connection with general functionality of a social networking service. As well, the date management component 934 can be employed to plan and/or schedule a date in accordance with the innovation.

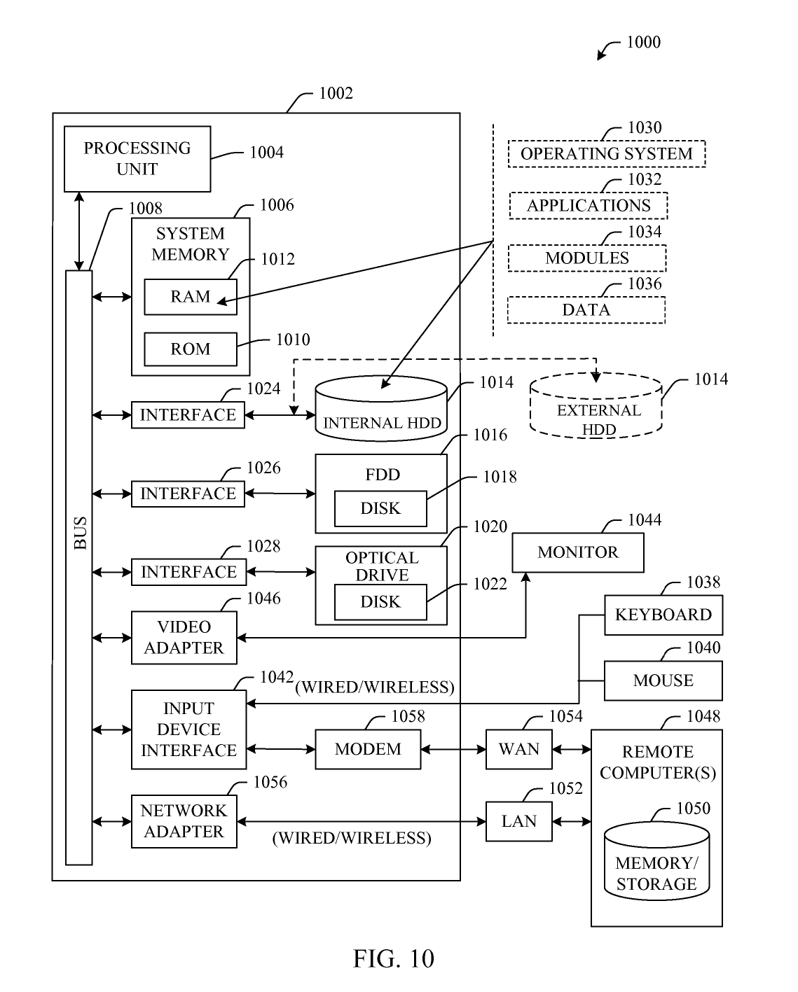

Referring now to FIG. 10, there is illustrated a block diagram of a computer operable to execute the disclosed architecture. In order to provide additional context for various aspects of the subject innovation, FIG. 10 and the following discussion are intended to provide a brief, general description of a suitable computing environment 1000 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term ‘modulated data signal’ means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the innovation includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the innovation can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real world performance similar to the basic 10 BaseT wired Ethernet networks used in many offices.

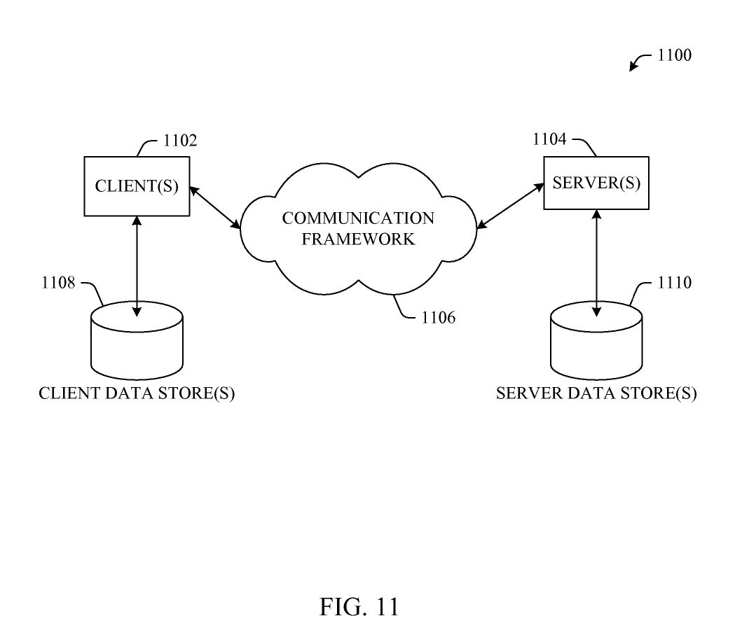

Referring now to FIG. 11, there is illustrated a schematic block diagram of an exemplary computing environment 1100 in accordance with the subject innovation. The system 1100 includes one or more client(s) 1102. The client(s) 1102 can be hardware and/or software (e.g., threads, processes, computing devices). The client(s) 1102 can house cookie(s) and/or associated contextual information by employing the innovation, for example.

The system 1100 also includes one or more server(s) 1104. The server(s) 1104 can also be hardware and/or software (e.g., threads, processes, computing devices). The servers 1104 can house threads to perform transformations by employing the innovation, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term ‘includes’ is used in either the detailed description or the claims, such term is intended to be inclusive in a manner similar to the term ‘comprising’ as ‘comprising’ is interpreted when employed as a transitional word in a claim.

What is claimed is:

1. A system that facilitates date management in a social networking environment, comprising:
a connection interface component that identifies a plurality of candidates within a social interaction service; and
a date management component that enables a user to post an advertisement of a date to a subset of the plurality of candidates.

2. The system of claim 1, further comprising a profile generation component that maintains a mini-profile of the user, wherein the mini-profile is included within the advertisement.

3. The system of claim 1, further comprising an advertising component that facilitates creation of the advertisement.

4. The system of claim 1, further comprising a search component that enables a candidate to search the social interaction system for the advertisement.

5. The system of claim 1, further comprising a respond component that enables a candidate to one of accept or decline the advertisement.

6. The system of claim 1, further comprising a notify component that triggers an alert to the user upon acceptance of the advertisement by a candidate.

7. The system of claim 6, wherein the alert is at least one of a text, voice, video or picture message.

8. The system of claim 1, further comprising a planning component that enables the user to establish a plan of the date.

9. The system of claim 1, wherein the date is planned via an asynchronous process.

10. The system of claim 1, wherein the date is planned via a real-time process.

11. The system of claim 1, further comprising at least one of a contextual awareness component or a machine learning and reasoning component employs at least one of contextual, a probabilistic or a statistical-based analysis that infers an action that the user desires to be automatically performed

12. A computer-implemented method of establishing a real world date associated with a virtual encounter within a social networking environment, comprising:
selecting a type of advertisement for the real world date;
specifying a plurality of parameters related to the real world date; and
posting the advertisement within the virtual social networking environment.

13. The computer-implemented method of claim 12, wherein the plurality of parameters includes at least one of time/day, place, title, or description.

14. The computer-implemented method of claim 12, wherein the type is a reverse advertisement.

15. The computer-implemented method of claim 12, further comprising posting a reply request date associated with the advertisement.

16. The computer-implemented method of claim 12, further comprising transmitting the advertisement to a target set of candidates based upon profile criteria.

17. A social interaction system, comprising.
means for planning a date that transitions an encounter from a virtual space into a real world space;
means for generating an advertisement that describes the date; and
means for conveying the advertisement to a select group of candidates within a social network environment.

18. The system of claim 17, wherein the advertisement is a reverse advertisement.

19. The system of claim 18, further comprising means for identifying the select group of candidates.

20. The system of claim 19, further comprising means for uploading a description of the date into the advertisement, wherein the description is at least one of a text, audio, video, or picture description.
